(19) United States
(12) Patent Application Publication
(10) Pub. No.: US 2009/0052363 A1
(43) Pub. Date: Feb. 26, 2009

(54) WIRELESS COMMUNICATION SYSTEM AND WIRELESS COMMUNICATION APPARATUS

(75) Inventors: Kiyotaka Matsue, Yokohama-shi (JP); Youichirou Shiba, Fuchu-shi (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/193,514

(22) Filed: Aug. 18, 2008

(30) Foreign Application Priority Data
Aug. 20, 2007 (JP) 2007-213876

(51) Int. Cl. H04H 20/71

(52) U.S. Cl. 370/312

(57) ABSTRACT

Wireless communication is performed between an access point and a plurality of wireless terminals pursuant to standard of wireless LAN communication. The access point transmits a plurality of data frames to the plurality of wireless terminals by one communication of multicast communication and broadcast communication and designates some of the plurality of wireless terminals to return Block Acknowledgement frames as an acknowledgement response. The designated wireless terminals produce the Block Acknowledgement frames and return them to the access point when required to return the Block Acknowledgement frames from the access point.

### CROSS-REFERENCE TO RELATED APPLICATIONS

This application is based upon and claims the benefit of priority from prior Japanese Patent Application No. 2007-213876, filed Aug. 20, 2007, the entire contents of which are incorporated herein by reference.

### BACKGROUND OF THE INVENTION

1. Field of the Invention

The present invention relates to a wireless communication system and a wireless communication device. More particularly, it relates to a wireless communication system in which data communication is performed by a broadcast system and a multicast system under Wireless LAN communication environment, and a wireless communication device for use in the system.

2. Description of the Related Art

Wireless LAN communication is communication which is performed in accordance with a frame format and a protocol for communication control defined by the standard of IEEE802.11 stipulated by the Institute of Electrical and Electronics Engineers (hereinafter referred to as IEEE) (e.g., see IEEE standard 802.11, 1999 Edition, IEEE standard 802.11e, 2005).

As a data communication method in a medium access control (MAC) layer according to the standard of this wireless LAN communication, three types of methods are defined. That is, they are a unicast (UC) system in which data is transmitted to one specific wireless terminal, a broadcast (BC) system in which data is transmitted to all wireless terminals, and a multicast (MC) system in which data is transmitted to one or more specific wireless terminals. Among these systems, in the UC system, there is introduced a mechanism in which acknowledgment (hereinafter referred to as the ACK) is performed with respect to the data transmission. However, in the BC system or the MC system, there are not introduced a mechanism in which the ACK is performed with respect to the data transmission and a mechanism of block acknowledgment (Block ACK) (hereinafter referred to as the BA) with respect to a plurality of frames.

Incidentally, the IEEE standard 802.11e defines the format of the BA frame in transmission of a plurality of data frames.

Under the circumstances, it is desired to provide a means of successfully returning an ACK to a data frame transmitted utilizing a frame transmitting system of the MC system or the BC system. A method for determining the returning order of ACKs before communication start so as to prevent timings of returning actions of ACKs from a plurality of wireless terminals from overlapping with one another is considered, in order to avoid collision of frames transmitted from the wireless terminals. At this time, a data frame requiring returning of ACK is prepared for communication conducted by the BC system or the MC system. When the number of terminals taking part in a group of communications conducted by the BC system or the MC system is fixed or variable, timings of returning actions of ACKs to communications conducted by the BC system or the MC system are adjusted at the transmission source in advance. Thereby, collision of ACK frames transmitted from a plurality of wireless terminals is avoided so that a wireless terminal which has transmitted an ACK frame can be identified on a reception side. It is thought that a wireless terminal which can interpret a data frame according to the MC system or the BC system requiring returning of ACK is set and a waiting time until ACK is returned is changed.

However, in such a method, since an ACK is returned from a wireless terminal each time data is transmitted to the wireless terminal, a communication speed lowers, which thus necessitates a communication procedure to be further devised. Thus, it is desired to provide a wireless communication apparatus which can perform a plurality of acknowledgments using one BA frame to a plurality of frame transmissions according to communication of the MC system or the BA system under Wireless LAN communication environment.

### BRIEF SUMMARY OF THE INVENTION

According to an aspect of the present invention, there is provided a wireless communication system in which wireless communication is performed between an access point and a plurality of wireless terminals, wherein the access point is configured to transmit a plurality of data frames to the wireless terminals by one of multicast communication and broadcast communication and designate some of the wireless terminals and request such wireless terminals designated to return Block Acknowledgement frames as an acknowledgement response, and designated wireless terminals are configured to produce the Block Acknowledgement frames to return the Block Acknowledgement frames to the access point when returning of the Block Acknowledgement frames is requested from the access point.

### BRIEF DESCRIPTION OF THE SEVERAL VIEWS OF THE DRAWING

FIG. 1 is a configuration diagram of Wireless LAN communication system according to an embodiment of the present invention;

FIG. 2 is a block diagram showing one example of hardware of an access point and a wireless terminal in FIG. 1;

FIG. 3 is a diagram showing a MAC Frame Format used in an embodiment of the present invention;

FIG. 4 is a diagram showing a relationship of designation of type of ACK policy by Bit 5 to Bit 7 of 2 byte data configuring frame information QoS Control in FIG. 3;

FIG. 5 is a sequence diagram showing a first operation example where, when an access point and two wireless terminals are present within a BSS, transmission of data frames and return of BA and ACK frames are performed between the access point and the two wireless terminals in the system shown in FIG. 1;

FIG. 6 is a sequence diagram showing a second operation example where, when an access point and two wireless terminals are present within a BSS, transmission of data frames and return of BA and ACK frames are performed between the access point and the two wireless terminals in the system shown in FIG. 1;

FIG. 7 is a sequence diagram showing a third operation example where, when an access point and two wireless terminals are present within a BSS, transmission of data frames and return of BA and ACK frames are performed between the access point and the two wireless terminals in the system shown in FIG. 1;

FIG. 8 is a sequence diagram showing a fourth operation example where, when an access point and two wireless terminals are present within a BSS, transmission of data frames and return of BA and ACK frames are performed between the access point and the two wireless terminals in the system shown in FIG. 1;

FIG. 9 is a sequence diagram showing a fifth operation example where, when an access point and two wireless terminals are present within a BSS, transmission of data frames and return of BA and ACK frames are performed between the access point and the two wireless terminals in the system shown in FIG. 1;

FIG. 10 a sequence diagram showing a sixth operation example where, when an access point and two wireless terminals are present within a BSS, transmission of data frames and return of BA and ACK frames are performed between the access point and the two wireless terminals in the system shown in FIG. 1;

FIG. 11 a sequence diagram showing an seventh operation example where, when an access point and two wireless terminals are present within a BSS, transmission of data frames and return of BA and ACK frames are performed between the access point and the two wireless terminals in the system shown in FIG. 1;

FIG. 12 is a flowchart showing an operation example when an access point prepares a management table for determining a transmission destination of a BAR frame in the system shown in FIG. 1;

FIG. 13 is a diagram showing a first example of the management table determined according to the operation of the flowchart shown in FIG. 12;

FIG. 14 is a diagram showing a second example of the management table determined according to the operation of the flowchart shown in FIG. 12;

FIG. 15 is a diagram showing a third example of the management table determined according to the operation of the flowchart shown in FIG. 12;

FIG. 16 is a flowchart showing an operation example when the access point transmits a data frame and a BAR frame in the system shown in FIG. 1;

FIG. 17 is a flowchart showing an operation example when the access point receives a data frame including BA frame in the system shown in FIG. 1;

FIG. 18 is a flowchart showing an operation example when the wireless terminal receives a data frame including BAR frame in the system shown in FIG. 1; and

FIG. 19 is a block diagram showing a wireless communication system according an application example of the present invention.

### DETAILED DESCRIPTION OF THE INVENTION

An embodiment of the present invention will be explained below with reference to the drawings. In the explanation, common parts or portions are attached with common reference numerals throughout all the figures.

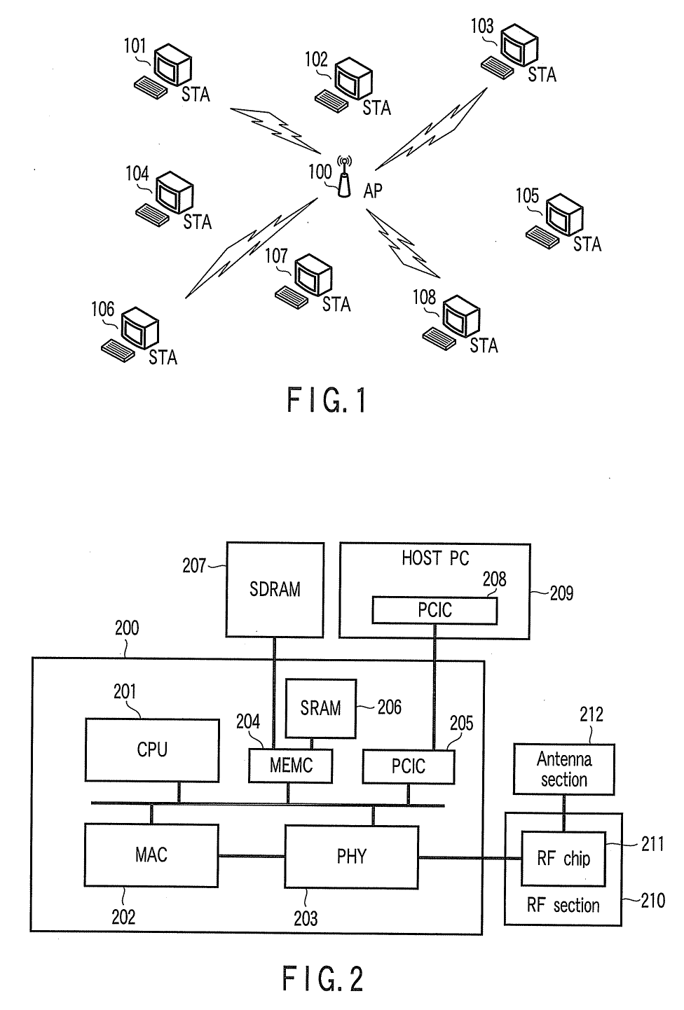

FIG. 1 shows one example of Wireless LAN communication system according to an embodiment of the present invention. Wireless LAN communication system shown in FIG. 1 shows an example where an access point (AP) 100, which is a master station, and a plurality of (eight in this embodiment) wireless terminals (STA) 101 to 108, which are slave stations, are present within a Basic Service Set (BSS). The access point 100 has functions of performing MC communication for conducting data transmission to many specific wireless terminals all at once, performing BC communication for conducting data transmission to general wireless terminals all at once, and performing UC communication for conducting data transmission to a specific wireless terminal, pursuant to any one of Standard of IEEE 802.11, IEEE 802.11e, and IEEE 802.11n Draft 2.0 of Wireless LAN communication. Each of the wireless terminals 101 to 108 has functions of performing MC communication for conducting data transmission to the access point 100 and many specific wireless terminals other than itself all at once, performing BC communication for conducting data communication to the access point 100 and general wireless terminals other than itself all at once, and performing UC communication for conducting data transmission to the access point 100 or a specific wireless terminal other than itself, pursuant to any one of Standard of IEEE 802.11, IEEE 802.11e, and IEEE 802.11n Draft 2.0 of Wireless LAN communication.

FIG. 2 is a block diagram showing a hardware configuration of the access point 100 and each of the wireless terminals 101 to 108 in FIG. 1. In FIG. 2, reference numeral 200 denotes a wireless LAN baseband chip, 201 denotes a Central Processing Unit (CPU), 202 denotes a Medium Access Controller (MAC) layer block, 203 denotes a Physical layer (PHY) layer block, 204 denotes a Memory Controller (MEMC), 205 denotes a Peripheral Components Interconnect Controller (PCIC), 206 denotes a Static Random Access Memory (SRAM), 207 denotes a Synchronous Dynamic Random Access Memory (SDRAM), 208 denotes a Peripheral Components Interconnect Controller (PCIC), 209 denotes a Host Personal Computer (HOST PC), 210 denotes a wireless section (RF section), 211 denotes an RF chip, and 212 denotes an antenna section.

Here, a basic operation of the hardware shown in FIG. 2 will be explained. Data transmitted from HOST PC 209 is stored in a memory (SRAM 206 or DRAM 207) via PCIC 208 in the host side and PCIC 205 within the wireless LAN baseband chip 200. Access to SRAM 206 or SDRAM 207 is performed via MEMC 204. Data stored in the memory is processed by CPU 201, and it is then output to the wireless section 210 via the MAC layer block 202 and the PHY layer block 203, the data is transferred from the RF chip 211 to antenna section 212 and finally transmitted as a frame of the wireless LAN. Data reception is processed according to a flow reversed to the data transmission.

Incidentally, a processing of content described in the present embodiment can be implemented by software or hardware. When the processing is implemented by hardware, the processing is implemented in the MAC layer block 202, and when the processing is implemented by software, the processing is implemented in the CPU 201.

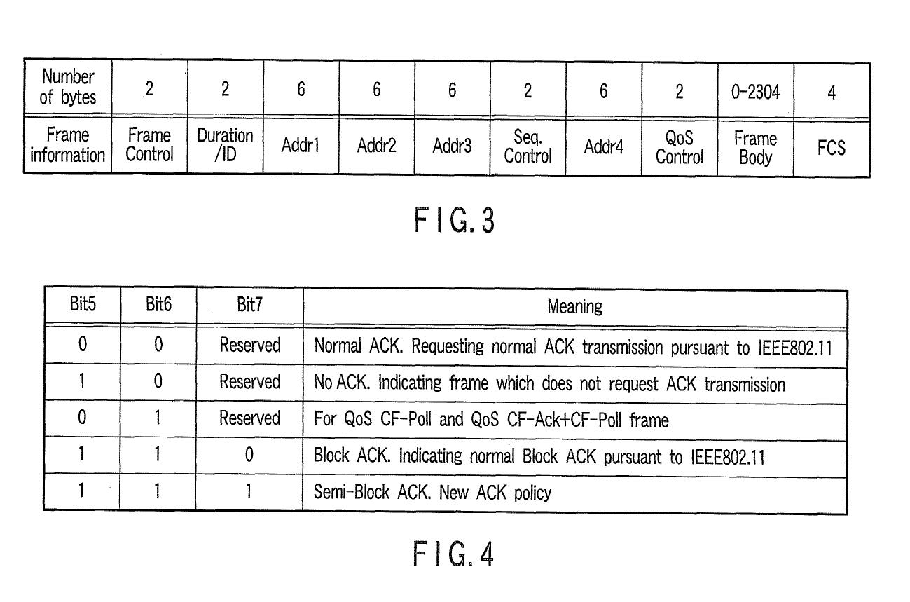

FIG. 3 shows the MAC Frame Format used in the present embodiment. In FIG. 3, frame information including Frame Control, Duration/ID, Addr1, Addr2, Addr3, Seq. Control, Addr4, QoS Control, Frame Body, and FCS is shown in a lower stage, and the numbers of bytes of respective information items are shown on an upper stage correspondingly.

A type of ACK policy is designated by Bit 5 to Bit 7 of 2 bytes (Bit 0 to Bit 15) of the frame information QoS Control in FIG. 3. In FIG. 4, a correspondence relationship between values of 3 bits, Bit 5 to Bit 7, of the frame information QoS Control and types of ACK policy. In the present embodiment, a new Semi-Block ACK policy is designated by Bit5=1, Bit6=1, and Bit7=1. Incidentally, the Normal ACK policy is designated by Bit 5, 6, 7=0, 0, Reserved, which shows a frame requiring ordinary ACK transmission pursuant to IEEE 802.11. NO ACK policy is designated by Bit 5, 6, 7=1, 0, Reserved, which shows a frame which does not require ACK transmission. A QoS CF-Poll and QoS CF-Ack+CF-Poll frame is shown by Bit 5, 6, 7=0, 1, Reserved. Further, an ordinary Block ACK policy pursuant to IEEE 802.11e is shown by Bit 5, 6, 7=1, 1, 0.

Each of the wireless terminals 101, 102, . . . , 108 shown in FIG. 1 has functions such as described below.

(a) When receiving data frame sent, each wireless terminal determines whether the data frame is a data frame transmitted from the access point 100 by MC communication or BC communication.

(b) As the determination result, when the wireless terminal recognizes that the data frame is the data frame transmitted from the access point 100 by MC communication or BC communication and the wireless terminal knows that return of Block ACK is required as an acknowledgement response to reception content, the wireless terminal records such a fact in the firmware of the CPU 201 shown in FIG. 2, described later. The wireless terminal transmits a Block ACK frame (including lacked notification information which could not be received) to the access point and the other wireless terminals other than itself in the Immediate BA format or Delayed BA format by MC communication or BC communication.

### FIRST OPERATION EXAMPLE

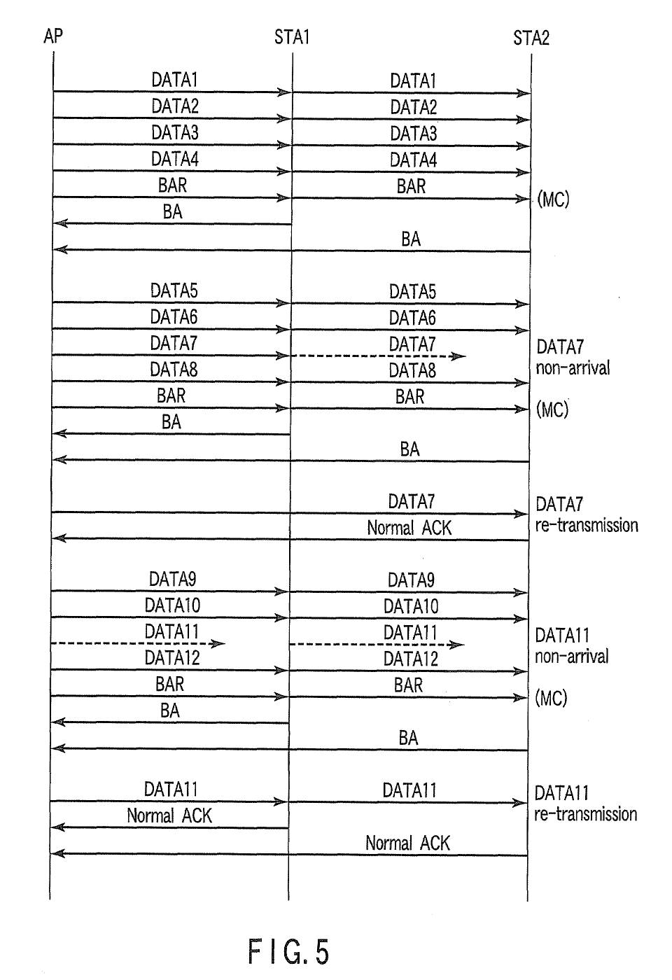

In order to simplify explanation in the wireless LAN communication system shown in FIG. 1, FIG. 5 shows an operation sequence where an access point AP and two wireless terminals STA1 and STA2 are present in a BSS, a frame including ordinary data and BAR (Block Acknowledgement Request) is transmitted from the access point AP by MC communication or BC communication, and frames including BA are transmitted from the two wireless terminals STA1 and STA2 according to the Immediate BA system.

Now, it is assumed that MC frames are transmitted from the access point AP to the two wireless terminals STA1 and STA2. In this case, it is assumed that a control protocol for communication establishment is established between the access point AP and the two wireless terminals STA1 and STA2 and the access point and the wireless terminals are in an environment which allows mutual communication (communication-enabling state (State 3) regulated by the IEEE 802.11 standard).

As shown in FIG. 5, after the access point AP transmits data frames DATA1 to DATA4 to the wireless terminals STA1 and STA2 by MC communication, the access point AP transmits a BAR frame by MC communication. After the wireless terminal STA1 receives the BAR frame, the wireless terminal STA1 transmits a BA frame. After the wireless terminal STA2 receives the BAR frame, the wireless terminal STA2 transmits a BA frame after a time for transmission of the BA frame conducted by the wireless terminal STA1 and (2*SIFS) time (SIFS is short interframe space) of the data transmission interval has elapsed.

Further, after the access point AP transmits data frames DATA5 to DATA8 to the wireless terminals STA1 and STA2 by MC communication or BC communication, the access point AP transmits a BAR frame by MC communication or BC communication. After the wireless terminal STA1 receives the BAR frame, the wireless terminal STA1 transmits a BA frame. After the wireless terminal STA2 receives the BAR frame, the wireless terminal STA2 transmits a BA frame after a time for transmission of the BA frame conducted by the wireless terminal STA1 and (2*SIFS) time has elapsed.

At this time, the wireless terminal STA2 cannot receive data frame DATA7. Information indicating non-reception of the data frame DATA7 is included in the BA frame which is thereafter transmitted from the wireless terminal STA2. The BA frame is received at the access point AP so that the access point AP can know such a fact that the wireless terminal STA2 could not receive data frame DATA7. After the access point AC receives the BA frame from the wireless terminal STA2, the access point AC re-transmits data frame DATA7. After re-transmission of the data frame, the wireless terminal STA2 transmits a Normal ACK frame. However, a BA frame can be included in the subsequent BA sequence to be transmitted.

Further, after the access point AP transmits data frames DATA9 to DATA12 to the wireless terminals STA1 and STA2 by MC communication, the access point AP transmits a BAR frame by MC communication. After the wireless terminal STA1 receives the BAR frame, the wireless terminal STA1 transmits a BA frame. After the wireless terminal STA2 receives the BAR frame, the wireless terminal STA2 transmits a BA frame after a time for transmission of the BA frame conducted by the wireless terminal STA1 and (2*SIFS) time has elapsed.

At this time, the data frame DATA11 does not reach the wireless terminals STA1 and STA2. Information indicating non-reception of the data frame DATA11 is included in BA frames transmitted from the wireless terminals STA1 and STA2. BA frames are received at the access point AP, the access point AP knows such a fact that the wireless terminals STA1 and STA2 could not receive the data frame DATA11. After the access point AP receives BA frames from the wireless terminals STA1 and STA2, the access point AP re-transmits the data frame DATA11 by MC communication or BC communication. In re-transmission of the data frame, the wireless terminals STA1 and STA2 transmit a Normal ACK frame. However, a BA frame can be included in the subsequent BA sequence to be transmitted.

### SECOND OPERATION EXAMPLE

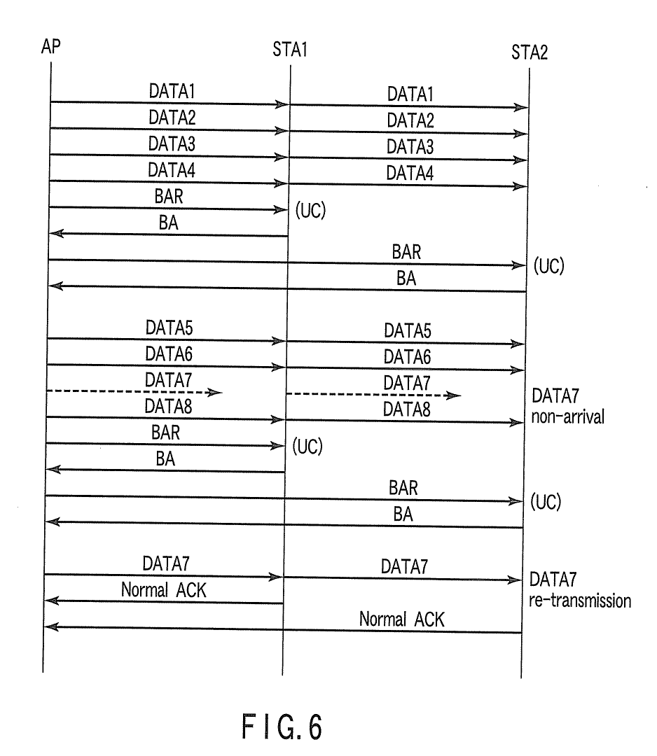

In the sequence shown in FIG. 5, such a deformation or modification may be adopted that the access point AP transmits a BAR frame to a specific wireless terminal by UC communication. FIG. 6 shows an operation sequence where the access point AP transmits ordinary data frames by MC communication and transmits a BAR frame by UC communication and the wireless terminals STA1 and STA2 transmit BA frames utilizing the Immediate BA system in the system shown in FIG. 1.

The sequence shown in FIG. 6 is the same as the sequence shown in FIG. 5 regarding a re-transmitting method of a data frame or the like, but the BAR frame is transmitted to each of the wireless terminals by UC communication in the former sequence, which is different from the latter sequence.

Like the sequence shown in FIG. 5 or FIG. 6, acknowledgement response by the Immediate BA system of MC communication data can be implemented in the system shown in FIG. 1. Thereby, re-transmission of the data frame by the MC communication is made possible, so that a frame loss rate can be reduced, in terms of the application. Since the acknowledgement response of MC communication data is applied to the BA system, a more effective utilization of a wireless band can be achieved than in the ordinary acknowledgement response system (Normal ACK system).

### THIRD OPERATION EXAMPLE

A third operation sequence has such a configuration that the wireless terminals return BA frames by the Delayed BA system in the abovementioned first and second operation sequences.

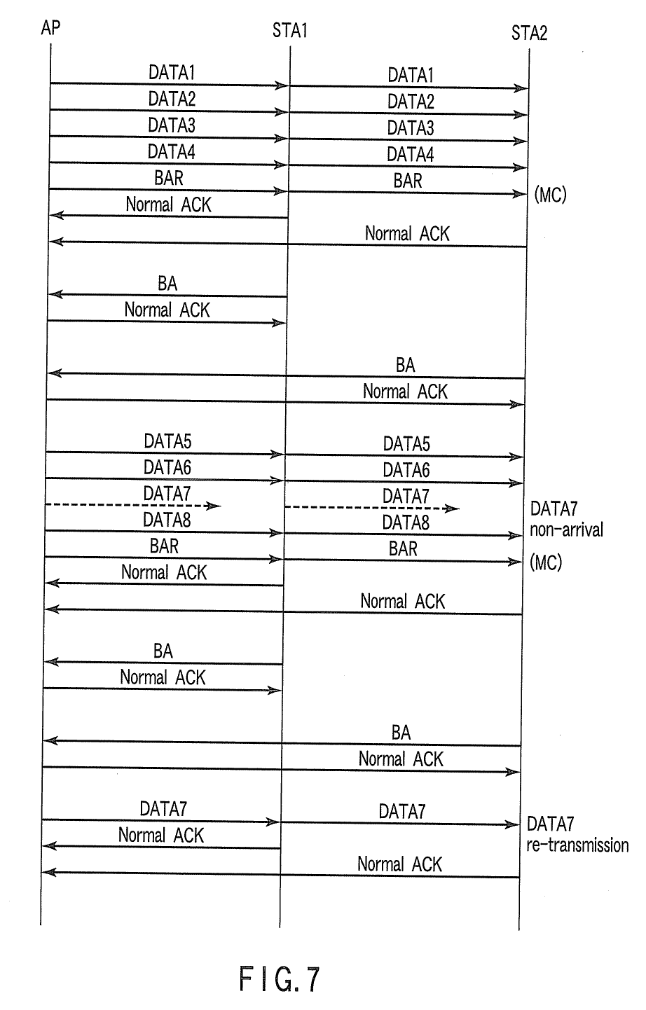

FIG. 7 shows an operation sequence where the access point AP transmits ordinary data frames and BAR frame by MC communication and the wireless terminals STA1 and STA2 transmit BA frames utilizing the Delayed BA system in the system shown in FIG. 1.

In the sequence shown in FIG. 7, the access point AP transmits data frames DATA1 to DATA4 to the wireless terminals STA1 and STA2 by MC communication and then transmits a BAR frame by MC communication. After the wireless terminals STA1 and STA2 receive BAR frames, the wireless terminal STA1 first transmits a Normal ACK and subsequently the wireless terminal STA2 transmits a Normal ACK. Thereafter, the wireless terminal STA1 transmits a BA frame, and upon receipt thereof, the access point AP transmits a Normal ACK to the wireless terminal STA1. Subsequently, the wireless terminal STA2 transmits a BA frame, and upon receipt thereof, the access point AP transmits a Normal ACK to the wireless terminal STA2.

Further, after the access point AP transmits data frames DATA5 to DATA8 to the wireless terminals STA1 and STA2 by MC communication, access point AP transmits a BAR frame by MC communication. After the wireless terminals STA1 and STA2 receive BAR frames, the wireless terminal STA1 first transmits a Normal ACK and subsequently the wireless terminal STA2 transmits a Normal ACK. Thereafter, the wireless terminal STA1 transmits a BA frame and upon receipt thereof, the access point AP transmits a Normal ACK to the wireless terminal STA1. Subsequently, the wireless terminal STA2 transmits a BA frame and upon receipt thereof, the access point AP transmits a Normal ACK to the wireless terminal STA2.

At this time, frame loss occurs during transmission of the data frame DATA7. Information indicating that the wireless terminals STA1 and STA2 do not receive data frame DATA7 is included in BA frames transmitted from the wireless terminals STA1 and STA2 thereafter, respectively. The access point AP receives respective BA frame, the access point AP can know that the wireless terminals STA1 and STA2 could not receive the data frames DATA7. After the access point AP receives the BA frames transmitted from the wireless terminals STA1 and STA2, the access point AP re-transmits the data frame DATA7. In re-transmission of the data frame, a user data is transmitted by MC communication, a BA frame for the user data is transmitted by the Normal ACK system in this example. However, a BA frame can be included in the subsequent BA sequence to be transmitted.

### FOURTH OPERATION EXAMPLE

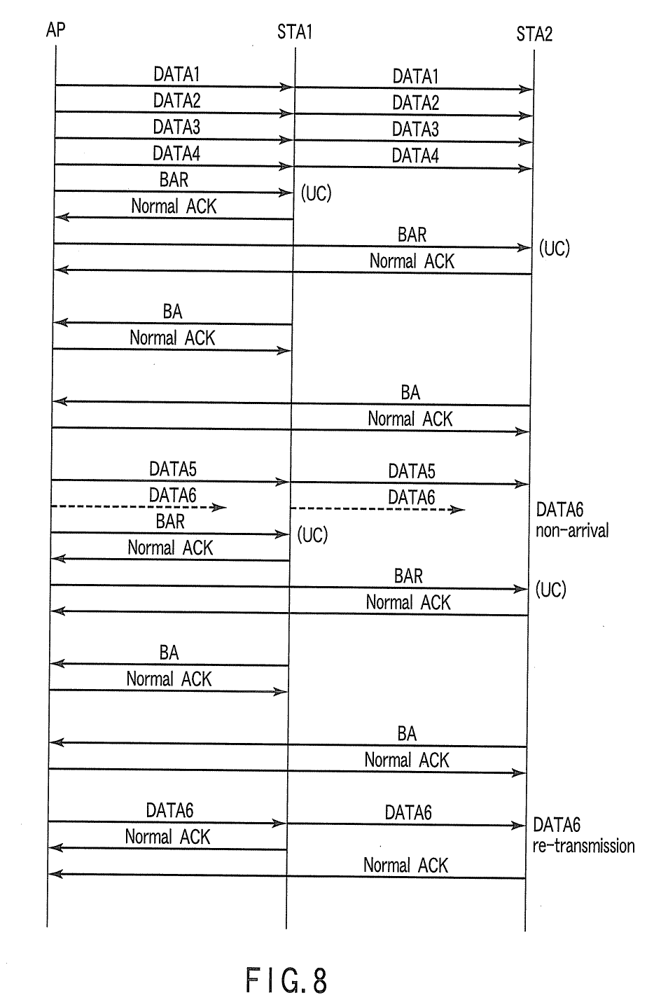

In the sequence shown in FIG. 7, such a deformation or modification can be adopted that the access point AP transmits BAR frame to a specific wireless terminal by UC communication. FIG. 8 shows an operation sequence where the access point AP transmits ordinary data frames by MC communication and transmits a BAR frame by UC communication, and the wireless terminals transmit BA frames by the Delayed BA system in the system shown in FIG. 1.

The sequence shown in FIG. 8 is the same as the sequence shown in FIG. 7 regarding a re-transmitting method of a data frame or the like, but the BAR frame is transmitted by UC communication in the former sequence, which is different from the latter sequence.

Like the sequence shown in FIG. 7 or FIG. 8, acknowledgement response by the Delayed BA system of MC communication data can be implemented. Thereby, re-transmission of the data frame is made possible, so that a frame loss rate can be reduced, in view of the application. Since the acknowledgement response of MC communication data is applied to the BA system, effective utilization of a wireless band higher than that in the ordinary acknowledgement response system (Normal ACK system) can be achieved.

In this example, frame loss occurs during transmission of the data frame DATA6 performed by the access point AP. Information indicating that the wireless terminals STA1 and STA2 did not receive the data frame DATA6 is included in BA frames transmitted from the wireless terminals STA1 and STA2 thereafter. Since the access point AP receives BA frames, the access point AP can know whether or not the wireless terminals STA1 and STA2 have received the data frame DATA6. After the access point AP receives BA frames from the wireless terminals STA1 and STA2, the access point AP re-transmits the data frame DATA6. In re-transmission of the data frame, a BA frame is transmitted by the Normal ACK system in this example. However, a BA frame can be included in the subsequent BA sequence to be transmitted.

Now, according to the IEEE 802.11e standard, an ACK policy is determined for each frame, so that a wireless terminal which has received the frame must operate according to the ACK policy described in the frame. Such a policy that a wireless terminal which has received a BAR frame returns a BA frame is already present in the IEEE 802.11e Standard. If a transmission destination of a BAR frame can be selected freely, a frame loss rate viewed from an application can be changed corresponding to respective wireless terminals, so that efficient wireless communication can be performed. Hereinafter, operation sequences for realizing this will be explained.

### FIFTH OPERATION EXAMPLE

A fifth operation example is an example where the access point AP transmits BAR frame to only some specific wireless terminals by UC communication and only the specific wireless terminals implement an acknowledgement response in the abovementioned first operation example.

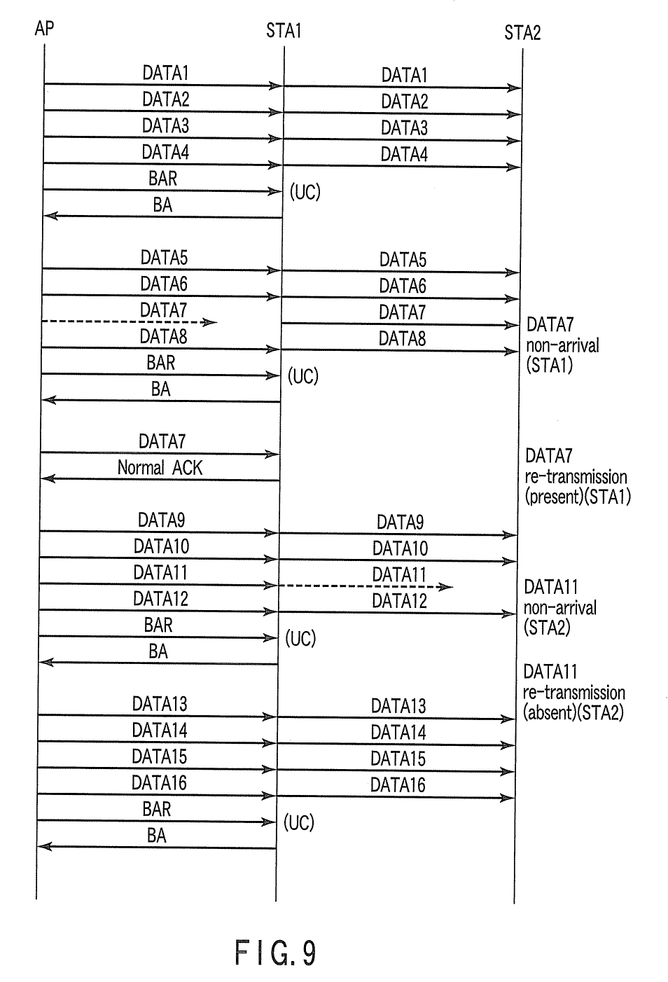

FIG. 9 shows an operation sequence where the access point AP transmits ordinary data frames to the wireless terminal STA1 by MC communication and transmits a BAR frame to the wireless terminal STA1 by UC communication, and the wireless terminal STA1 transmits a BA frame utilizing the Immediate BA system.

In the sequence shown in FIG. 9, the access point AP transmits data frames DATA1 to DATA4 to the wireless terminals STA1 and STA2 by MC communication, and thereafter the access point AP transmits a BAR frame to the wireless terminal STA1 by UC communication. At this time, the access point AP does not transmit a BAR frame to the wireless terminal STA2. After receiving the BAR frame, the wireless terminal STA1 transmits a BA frame to the access point AP.

Further, after the access point AP transmits data frames DATA5 to DATA8 to the wireless terminals STA1 and STA2 by MC communication, the access point AP transmits a BAR frame to the wireless terminal STA1 by UC communication. At this time, the access point AP does not transmit a BAR frame to the wireless terminal STA2. After receiving the BAR frame, the wireless terminal STA1 transmits a BA frame to the access point AP.

In this example, frame loss occurs during transmission of the data frame DATA7 performed by the access point AP. The wireless terminal STA2 receives the data frame DATA7 normally but the wireless terminal STA1 does not receive the data frame DATA7 normally. The information indicating non-reception is included in the BA frame transmitted from the wireless terminal STA1 thereafter. The access point AP receives the BA frame, so that it can know that the wireless terminal STA1 did not receive the data frame DATA7. After the access point AP receives the BA frame from the wireless terminal STA1, the access point AP re-transmits the data frame DATA7. In re-transmission of the data frame, the BA frame is transmitted by the Normal ACK system in this example. However, a BA frame can be included in the subsequent BA sequence to be transmitted.

Further, after the access point AP transmits data frames DATA9 to dATA12 to the wireless terminals STA1 and STA2 by MC communication, the access point AP transmits a BAR frame to the wireless terminals STA1 by UC communication. At this time, the access point AP does not transmit a BAR frame to the wireless terminal STA2. After receiving the BAR frame, the wireless terminal STA1 transmits a BA frame to the access point AP.

In this example, frame loss occurs during transmission of the data frame DATA11 performed by the access point AP. That is, the wireless terminal STA1 receives the data frame DATA11 normally but the wireless terminal STA2 does not receive the data frame normally. The access point AP cannot obtain information about frame loss indicating that the wireless terminal STA2 did not receive the data frame DATA11. Accordingly, re-transmission of the data frame to the wireless terminal STA2 is not performed.

### SIXTH OPERATION EXAMPLE

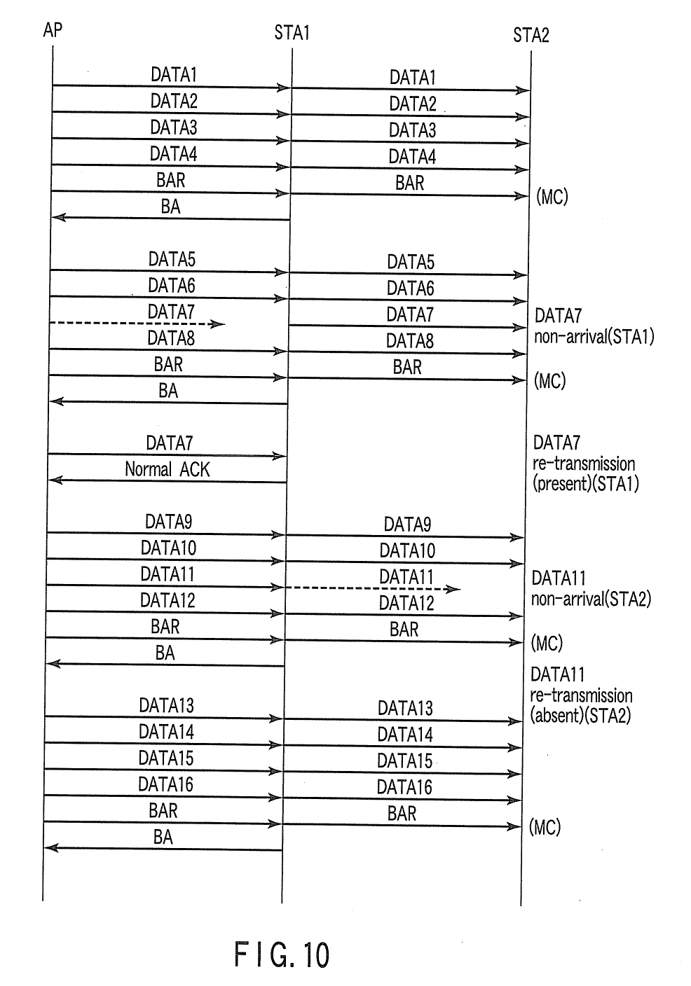

In the sequence shown in FIG. 9, such a deformation or modification can be adopted that the access point AP transmits a BAR frame to a plurality of wireless terminals by MC communication and acknowledgement response to specific wireless terminals is implemented. FIG. 10 shows an operation sequence where the access point AP transmits ordinary data frames by MC communication and transmits a BAR frame to the wireless terminals STA1 and STA2 by MC communication, where BA frame is transmitted from the specific wireless terminal STA1 utilizing the Immediate BA system. At this time, Semi-Block ACK policy shown in FIG. 4 is applied.

In the sequence shown in FIG. 10, the access point AP transmits ordinary data frames by MC communication and transmits a BAR frame to the wireless terminals STA1 and STA2 by MC communication, but the access point AP requests transmission of a BA frame to only the wireless terminal STA1. Thereby, after receiving the BAR frame, the wireless terminal STA1 transmits a BA frame but the wireless terminal STA2 does not conduct transmission of a BA frame.

Like the sequence shown in FIG. 9 or FIG. 10, since acknowledgement response to the wireless terminal STA1 is performed, re-transmission of data can be implemented even if frame loss occurs, which results in overall performance improvement, as viewed from the application. Since an acknowledgement response to the wireless terminal STA2 is not requested, a data re-transmission processing of the wireless terminal STA2 does not occur. Thereby, a re-transmission processing can be implemented solely for a wireless terminal requiring acknowledgement response, so that effective utilization of a wireless band can be achieved.

### SEVENTH OPERATION EXAMPLE

A seventh operation example is an example where an acknowledgement response is alternately implemented for a plurality of wireless terminals from the access point AP by UC communication in the abovementioned first operation example.

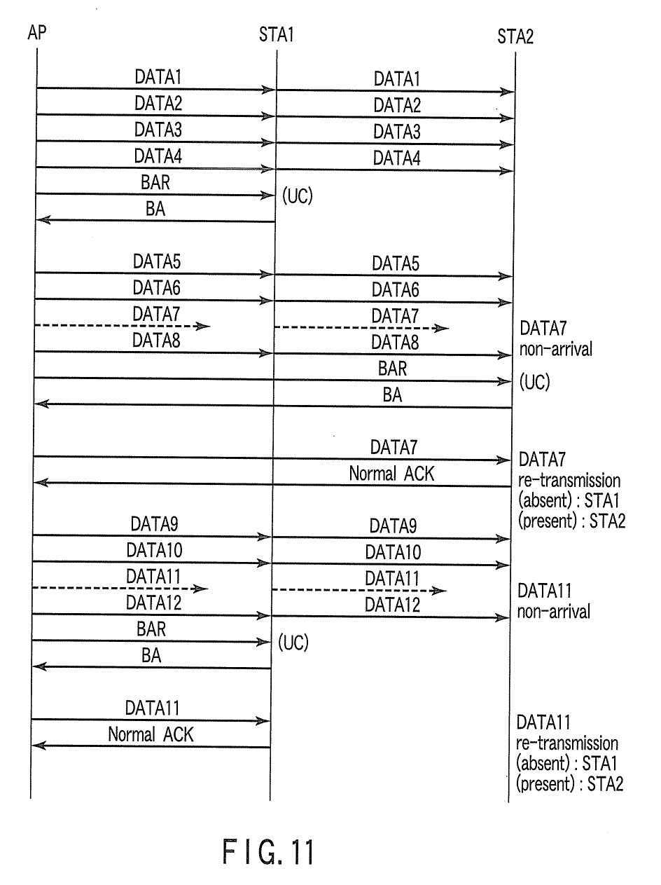

FIG. 11 shows an operation sequence where the access point AP transmits ordinary data frames to the wireless terminals STA1 and STA2 by MC communication and transmits a BAR frame to the wireless terminal STA1 by UC communication, the wireless terminal STA1 transmits a BA frame by utilizing the Immediate BA system, and subsequently the access point AP transmits ordinary data frames to the wireless terminals STA1 and STA2 by MC communication and transmits a BAR frame to the wireless terminal STA2 by UC communication, and the wireless terminal STA2 transmits a BA frame by utilizing the Immediate BA system in the wireless LAN communication system shown in FIG. 1.

In the sequence shown in FIG. 11, the access point AP transmits data frames DATA1 to DATA4 to the wireless terminals STA1 and STA2 by MC communication and then transmits a BAR frame to the wireless terminal STA1 by UC communication. At this time, the access point AP does not transmits the BAR frame to the wireless terminal STA2. After receiving the BAR frame, the wireless terminal STA1 transmits a BA frame to the access point AP.

After the access point AP receives the BA frame from the wireless terminal STA1, the access point AP transmits data frames DATA5 to DATA8 to the wireless terminals STA1 and STA2 by MC communication. Thereafter, the access point AP transmits a BAR frame to the wireless terminal STA2 by UC communication. At this time, the access point AP does not transmit BAR frame to the wireless terminal STA1. After receiving the BAR frame, the wireless terminal STA2 transmits a BA frame to the access point AP.

In this example, frame loss occurs during transmission of the data frame DATA7 performed by the access point AP. Information indicating that the wireless terminal STA2 did not receive the data frame DATA7 is included in BA frame transmitted form the wireless terminal STA2 thereafter. The access point AP receives the BA frame so that the access point AP can know whether or not the wireless terminal STA2 has received the data frame DATA7. After the access point AP receives the BA frame from the wireless terminal STA2, the access point AP performs re-transmission of the data frame DATA7 to the wireless terminal STA2 by UC communication or performs the re-transmission of the data frame DATA7 to the wireless terminals STA1 and STA2 by MC communication. In re-transmission of the data frame, the BA frame is transmitted by the Normal ACK system in this example. However, a BA frame can be included in the subsequent BA sequence to be transmitted. That is, BA acknowledgement response is implemented only to the wireless terminal STA2.

Further, after the access point AP transmits data frames DATA9 to DATA12 to the wireless terminals STA1 and STA2 by MC communication, the access point AP transmits a BAR frame to the wireless terminal STA1 by UC communication. At this time, the access point AP does not transmit a BAR frame to the wireless terminal STA2. After receiving the BAR frame, the wireless terminal STA1 transmits a BA frame to the access point AP.

In the example, frame loss occurs during transmission of the data frame DATA11 performed by the access point AP. That is, the wireless terminal STA1 receives the data frame DATA11 normally, but the wireless terminal STA2 does not receive the data frame normally. Since the access point AP cannot obtain information indicating that the data frame DATA11 cannot be received by the wireless terminal STA2, it does not perform a re-transmission processing. However, if the data received by the wireless terminal STA1 undergoes frame loss, it can be assumed that the data received by the wireless terminal STA2 also undergoes frame loss. Based on this assumption, data frame DATA11 may be transmitted by MC communication. In this case, frame loss information may be obtained from both terminals STA1 and STA2.

According to the seventh operation example, as shown in FIG. 11, the access point AP alternately transmits the BAR frame to the wireless terminals STA1 and STA2, which results in incomplete acknowledgement response control. However, since the number of times of transmission of control frames (BAR frame and BA frame) is reduced as compared with the ordinary acknowledgement response system, effective utilization of a wireless band can be achieved. This example is effective in such a case that it is desired to perform re-transmission control mainly to application temporally restricted such as streaming data as much as possible, namely, a case that sufficient band cannot be secured for acknowledgement response to all wireless terminals but it is desired to reduce block noise of the specific wireless terminal if only a little by performing the re-transmission control.

### EIGHTH OPERATION EXAMPLE

An eighth operation example is an example where the access point AP dynamically changes return of ACK frame or return request of BA frame to wireless terminals performing MC communication to dynamically change frames performing acknowledgement response in each of the abovementioned operation examples. That is, return of ACK frame or return request for BA frame explained regarding the first to seventh operation sequences is changed for each transmission of series of data frames including DATA1 to DATA4, DATA5 to DATA8, DATA9 to DATA12, . . . .

By dynamically changing a band-securing time in this manner, it is made possible to perform incomplete acknowledgement. In other words, complete data transmission and reception (complete acknowledgment request) is not aimed at all times. There may be streaming data that should be displayed despite inclusion of some noise. What is aimed with respect to such streaming data is a function that enables re-transmission of data to a maximal degree even if the transmission is incomplete.

The access point AP and the wireless terminals STA1 and STA2 perform transmission and reception of BAR frames and BA frames so that acknowledgement of user data can be implemented. At this time, since information can be collected only to a wireless terminal which has transmitted BAR frame, so that transmission sequence of unnecessary BAR frame and BA frame can be deleted. Thereby, a wireless band can be used efficiently. As one of the merits, there is such a fact that re-transmission processing can be moderately performed for all wireless terminals. This is an insufficient scheme as compared with a scheme of the complete acknowledgement (ordinary ACK sequence). However, improvement of data loss can be achieved as compared with data transmission in one direction where acknowledgement is not performed at all. Especially, if information indicating that only a specific wireless terminal cannot receive user data can be obtained, such a measure as lowering the data transmission rate or raising the transmission output power can be adopted at a time when the access point AP performs data transmission to the specific wireless terminal. By analyzing these information items statistically, it is made possible to change a transmission method of a BAR frame from “round robin” processing to “every time” processing to transmit user data to wireless terminals more stably.

The eighth operation example is effective in application to application utilization time of a streaming system, such as performing video transmission as a main purpose.

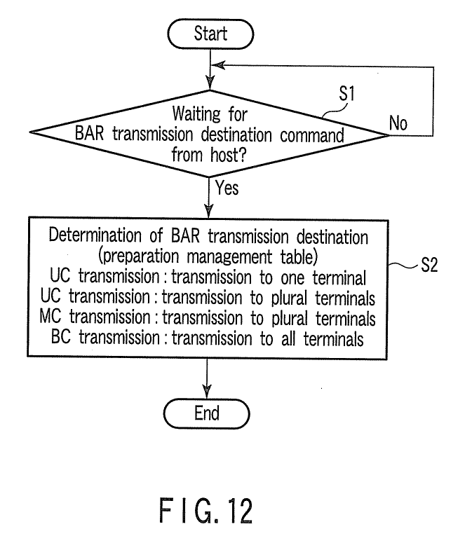

FIG. 12 is a flowchart showing an operation example when the access point AP prepares a management table for determining a transmission destination and a transmission method of a BAR frame in the first to eighth operation sequences. First, whether or not a transmission destination command of a BAR frame has been transmitted from the host PC 209 is determined (step S1). When the determination is affirmative (Yes), the transmission destination of a BAR frame is determined and a management table is prepared (step S2). The management table includes a MAC address provided, in advance, to the wireless terminal which is the transmission destination of a BAR frame, a transmission mode utilized at a transmission time of the BAR frame, such as MC communication, BC communication, UC communication, or the like, the number of times of transmission of a BAR frame, and information indicating whether or not a new Semi-Block ACK policy shown in FIG. 4 is designated to perform transmission.

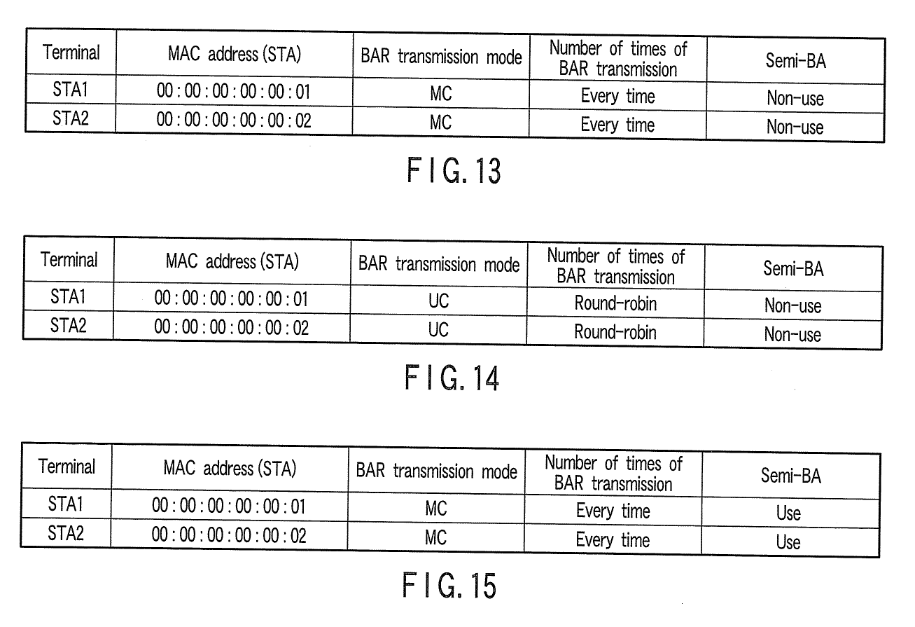

For example, when a BAR frame is transmitted according to the operation sequence shown in FIG. 5, a management table shown in FIG. 13 is prepared. In the management table shown in FIG. 13, a MAC address provided to the wireless terminal STA1 in advance is “00:00:00:00:00:01”, a BAR frame is transmitted to the wireless terminal STA1 by MC communication, and a BAR frame is transmitted for each transmission of a series of data frames, which indicates non-use of the Semi-BA policy, namely, that the Semi-BA policy is not designated. Further, in the management table shown in FIG. 13, a MAC address provided to the wireless terminal STA2 in advance is “00:00:00:00:00:02”, a BAR frame is transmitted to the wireless terminal STA2 by MC communication, and the BAR frame is transmitted for each transmission of a series of data frames, which indicates that the Semi-BA policy is not designated.

When a BAR frame is transmitted in an operation sequence such as shown in FIG. 6, a management table shown in FIG. 14 is prepared. In the management table shown in FIG. 14, a MAC address provided to the wireless terminal STA1 in advance is “00:00:00:00:00:01”, a BAR frame is transmitted to the wireless terminal STA1 by UC communication and the BAR frame is transmitted by round-robin for each transmission of a series of data frames, which indicates that the Semi-BA policy is not designated. Further, in the management table shown in FIG. 14, a MAC address provided to the wireless terminal STA2 in advance is “00:00:00:00:00:02”, a BAR frame is transmitted to the wireless terminal STA2 by UC communication and the BAR frame is transmitted by round-robin for each transmission of a series of data frames, which indicates that the Semi-BA policy is not designated. Incidentally, the transmission performed by the round-robin means that BAR frames are sequentially transmitted to a plurality of wireless terminals after transmission of a series of data frames, as shown in FIG. 6.

Further, when BAR frame is transmitted in an operation sequence such as shown in FIG. 10, a management table shown in FIG. 15 is prepared. In the management table shown in FIG. 15, a MAC address provided to the wireless terminal STA1 in advance is “00:00:00:00:00:01”, a BAR frame is transmitted to the wireless terminal STA1 by MC communication and the BAR frame is transmitted for each transmission of a series of data frames, which indicates that the Semi-BA policy is designated. Further, in the management table shown in FIG. 15, a MAC address provided to the wireless terminal STA2 in advance is “00:00:00:00:00:02”, a BAR frame is transmitted to the wireless terminal STA2 by MC communication and the BAR frame is transmitted for each transmission of a series of data frames, which indicates that the Semi-BA policy is designated. In this case, according to the designation of the Semi-BA policy, only the wireless terminal STA1 returns a BA frame to the access point AP. The wireless terminal STA2 does not return a BA frame.

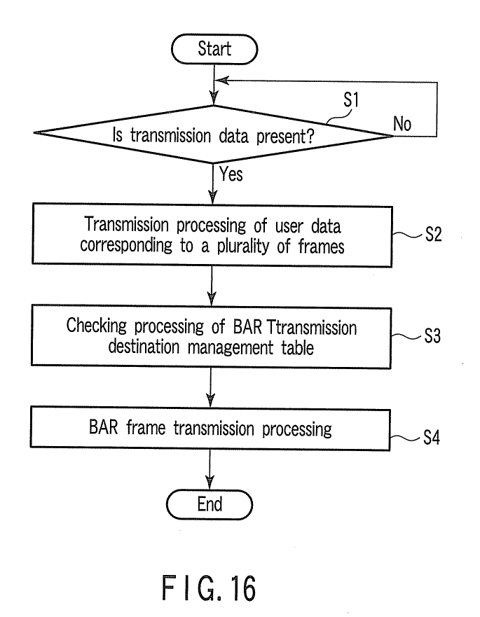

FIG. 16 is a flowchart showing an operation example when the access point AP transmits data frame and BAR frame. First, determination about presence/absence of transmission data is made (step S1). When there is transmission data, a transmission processing of user data corresponding to a plurality of frames is performed (step S2). Next, a transmission destination of a BAR frame, a transmission method, and the like are checked with reference to the management table prepared according to the operation shown in flowchart of FIG. 12 (step S3). Subsequently, a BAR frame is transmitted according to the management table (step S4).

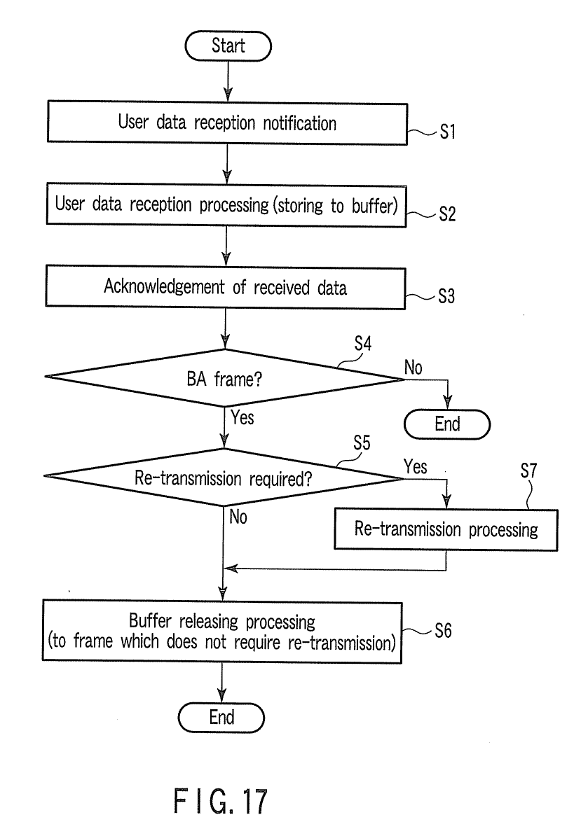

FIG. 17 is a flowchart showing an operation example when the access point AP receives data including a BA frame returned from the wireless terminal STA. First, notification indicating reception of data (user data) is received from the wireless terminal STA (step S1). Next, reception processing of the user data is performed, specifically, received user data is stored in a buffer (SRAM 206 or SDRAM 207 shown in FIG. 2) (step S2). Subsequently, acknowledgement of received data is performed (step S3). Next, whether or not the received data is a BA frame is determined (step S4). When the determination is negative (No), this processing is terminated. When the determination is affirmative (Yes), the content of the BA frame is examined, and whether or not re-transmission of the data frame is required is determined (step S5). When the re-transmission is not required (No), processing of releasing the buffer to the data frame which does not require the re-transmission is performed (step S6). On the other hand, when the re-transmission is required (Yes), a re-transmission processing of the data frame where frame loss occurred is performed (step S7). Thereafter, processing of releasing the buffer is performed (step S6).

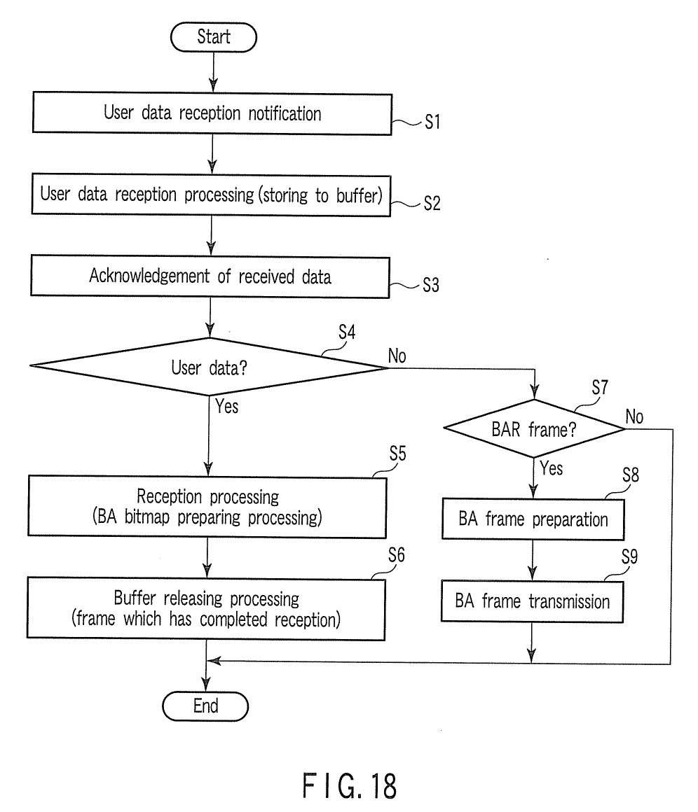

FIG. 18 is a flowchart showing an operation example on the side of the wireless terminal STA. First, notification indicating reception of data (user data) from the access point AP is received (step S1). Next, a reception processing of the user data is performed, specifically, the received user data is stored in the buffer (SRAM 206 or SDRAM 207 in FIG. 2) (step S2). Subsequently, acknowledgement of the received data is performed (step S3). Next, whether or not the received data is the user data is determined (step S4). When the determination is affirmative (Yes), a BA bitmap including data indicating whether or not the wireless terminal can receive data normally is prepared based upon the received data (step S5), and processing of releasing the buffer is then performed (step S6) to terminate the processing.

On the other hand, when the determination at the step S4 is negative (No), whether or not the received data is a BAR frame is determined (step S7). When the determination at the step S7 is affirmative (Yes), a BA frame is prepared (step S8) and the BA frame is transmitted (step S9). Incidentally, when the determination at the step S7 is negative (No), the data is of another control system frame or a management system frame. These data frames are processed by a processing step (not shown).

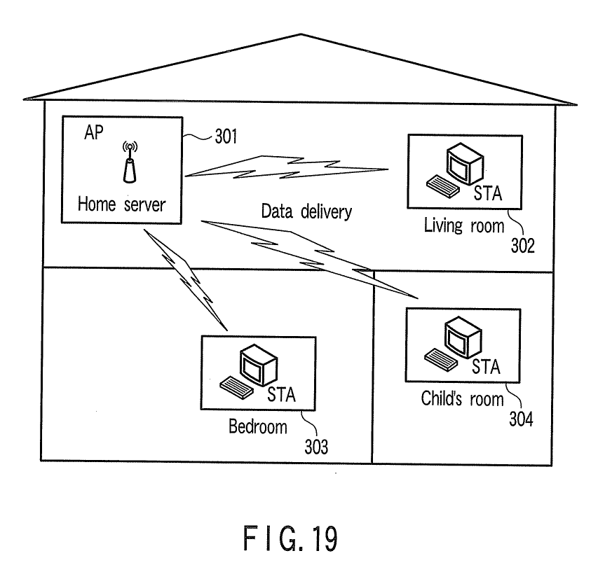

FIG. 19 shows a configuration of an application example of the present invention. This example is a wireless communication system where video data and sound data are stored in a home server 301 installed in an ordinary house, and video data and sound data are delivered from the home server 301 to three displays 302 to 304 via MC communication or BC communication of a wireless LAN communication concurrently. The home server 301 is installed, for example, in a living room and has a function similar to that of the access point AP shown in FIG. 1. Three displays, 302 to 304, each have a function similar to that of the wireless terminal STA, and the display 302 is installed, for example, in the living room, another display 303 being installed, for example, in a bedroom and the remaining display 304 being installed, for example, in a child's room. Here, data is delivered from the home server 301 to the three displays 302 to 304 concurrently by MC communication.

In a wireless communication system with such a configuration, when data is delivered from the home server 301 to three displays 302 to 304, transmission of data frame and BAR frame and return of BA frames are performed according to one sequence shown in the first to eighth operation examples explained above. For example, such a case is considered that the operation example shown in FIG. 10 is adopted where the home server 301 transmits data frame to three displays 302 to 304 by MC communication and transmits BAR frame to three displays 302 to 304 by MC communication, while a specific display 302 installed in the living room transmits a BA frame by utilizing the Immediate BA system. In this case, since acknowledgement response to the specific display 302 is performed, re-transmission of data can be implemented even if frame loss occurs, which results in overall performance improvement, as viewed from the application. Since acknowledgement response is not required to the other displays 303 and 304, a data re-transmission processing to both the displays 303 and 304 does not take place. Thereby, re-transmission processing to only a display requiring acknowledgement response can be implemented so that effective utilization of a wireless band can be achieved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wireless communication system in which wireless communication is performed between an access point and a plurality of wireless terminals,
wherein the access point is configured to transmit a plurality of data frames to the wireless terminals by one communication of multicast communication and broadcast communication and designate some of the wireless terminals to return Block Acknowledgement frames as acknowledgement response; and
the designated wireless terminals are configured to produce the Block Acknowledgement frames and return them to the access point when return of the Block Acknowledgement frames are requested from the access point.

2. The wireless communication system according to claim 1, wherein
the access point is configured to transmit a Block Acknowledgement Request frame to the wireless terminals designated by unicast communication.

3. The wireless communication system according to claim 1, wherein
the access point is configured to transmit a Block Acknowledgement Request frame to the wireless terminals by one communication of multicast communication and broadcast communication, the Block acknowledgement Request frame including data requesting return of the Block Acknowledgement frame from the wireless terminals designated.

4. The wireless communication system according to claim 1, wherein
the access point is configured to designate the wireless terminals sequentially to transmit Block Acknowledgement Request frames by unicast communication.

5. The wireless communication system according to claim 1, wherein
the access point is configured to change designation of the wireless terminal to be required for return of the Block Acknowledgement frame during transmission of the data frames.

6. The wireless communication system according to claim 1, wherein
the designated wireless terminals are configured to produce the Block Acknowledgement frames and return the Block Acknowledgement frames to the access point by using Immediate Block Acknowledgement mode when return of the Block Acknowledgement frames are requested from the access point.

7. The wireless communication system according to claim 1, wherein
the designated wireless terminals are configured to produce the Block Acknowledgement frames and return the Block Acknowledgement frames to the access point by using Delayed Block Acknowledgement mode when return of the Block Acknowledgement frames are requested from the access point.

8. The wireless communication system according to claim 1, wherein
the access point is configured to transmit the data frames to the wireless terminals pursuant to any one of IEEE 802.11, IEEE802.11e and IEEE802.11n Draft 2.0 of wireless LAN communication when transmitting the data frames to the wireless terminals, and the wireless terminals are configured to return the Block Ack frames pursuant to any one of IEEE 802.11, IEEE802.11e and IEEE802.11n Draft 2.0 of wireless LAN communication when returning the Block Ack frames.

9. An access point used in a wireless communication system where wireless communication is performed between the access point and a plurality of wireless terminals,
wherein the access point is configured to transmit a plurality of data frames to the wireless terminals by one communication of multicast communication and broadcast communication and prepare a management table including data designating a wireless terminal transmitting a Block Acknowledgement frame as an acknowledgement response and data designating a transmission mode of the Block Acknowledgement frame, and produce a Block Acknowledgement Request frame according to the management table after transmitting the data frame and transmit the Block Acknowledgement Request frame to the wireless terminal by a transmission mode according to the management table.

10. The access point according to claim 9, wherein
the access point is configured to transmit the data frames to the wireless terminals pursuant to any one of IEEE 802.11, IEEE802.11e and IEEE802.11n Draft 2.0 of wireless LAN communication when transmitting the data frames to the wireless terminals.
